(19) United States
(12) Patent Application Publication
(10) Pub. No.: US 2014/0269644 A1
(43) Pub. Date: Sep. 18, 2014

(54) ACKNOWLEDGEMENT RATE MODIFICATION IN WIRELESS COMMUNICATION SYSTEMS

(71) Applicant: QUALCOMM INCORPORATED, San Diego, CA (US)

(72) Inventors: Jibing Wang, San Diego, CA (US); Eric Y. Tsou, Palo Alto, CA (US); Joel Linsky, San Diego, CA (US)

(73) Assignee: QUALCOMM INCORPORATED, San Diego, CA (US)

(21) Appl. No.: 13/798,874

(22) Filed: Mar. 13, 2013

(51) Int. Cl. H04L 1/08

(52) U.S. Cl. CPC H04L 1/08
USPC 370/338

(57) ABSTRACT

Embodiments determine that interference between two radio transmissions is causing, or has the potential to cause, a network device to fail to receive acknowledgement packets. In response to such a determination, the embodiments lower an acknowledgement packet transmission bit rate to increase the likelihood that an acknowledgement packet can be successfully received, thereby avoiding needless retransmission of packets that have been successfully received.

### BACKGROUND

Embodiments of the inventive subject matter generally relate to the field of wireless communication systems, and, more particularly, to acknowledgement rate modification in wireless communications systems.

In wireless communication networks, interference from a transmitting radio can affect other radios in proximity to the transmitting radio. For example, many devices that implement a mobile wireless hotspot have two radios (e.g., a first radio for wireless networking with wireless peer devices and a second radio that communicates with a backhaul network). In such systems, the radio for communication with the backhaul network may interfere with a peer wireless device located at a relatively close proximity. As another example, a separate network device (a mobile phone or a second mobile hotspot) that is proximate to a peer wireless device may interfere with the peer wireless device.

As a result of such interference, acknowledgment packets may not be successfully received. In one such scenario, a peer wireless device transmits a data packet to an access point (e.g., a mobile wireless hotspot). The access point transmits the data packet to the backhaul network on one radio and may nearly simultaneously transmit an acknowledgement to the peer wireless device on a second radio. If the peer wireless device does not have adequate filtering technology, the transmission of the data packet to the backhaul network may interfere with the transmission of the acknowledgement packet, causing the peer wireless device to not receive the acknowledgement packet. As a result, the peer wireless device retransmits the data packet, even though it was successfully received by the access point.

### SUMMARY

System, method and machine-readable medium embodiments include receiving a packet from a network device. A determination is made that interference between two radio transmissions is causing, or has the potential to cause, the network device to fail to receive acknowledgement packets. In response to such a determination, the embodiments decrease an acknowledgement packet transmission bit rate by lowering the modulation order and/or coding rate. In some embodiments, the determination that interference between the two radio transmissions is or may be occurring can be based, at least in part, on receiving a retransmission of the packet after an acknowledgement has been sent. In alternative embodiments, the potential for interference may be determined in accordance with metrics used to determine proximity of the network device to an interfering radio source.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram depicting a networked system in which embodiments may be implemented.

FIG. 2 is a flowchart illustrating a method for determining an acknowledgement bit rate according to embodiments.

FIG. 3 is a flowchart illustrating a method for determining an acknowledgement bit rate according to alternative embodiments.

FIG. 4 is a sequence diagram providing an example operation of a method for determining an acknowledgement bit rate.

FIG. 5 is an example block diagram of one embodiment of an electronic device including a mechanism for proportionally scheduling packet transmissions in a communications network.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to configurations in which to radios are co-located, other configurations are possible in which the radios are not co-located. In other instances, well-known instruction instances, protocols, structures and techniques have not been shown in detail in order not to obfuscate the description.

Generally speaking, the embodiments determine that interference between two radio transmissions is causing, or has the potential to cause, a network device to fail to receive acknowledgement packets. In response to such a determination, the embodiments decrease an acknowledgement packet transmission bit rate to increase the likelihood that an acknowledgement packet can be successfully received, thereby avoiding needless retransmission of packets that have been successfully received.

FIG. 1 is a block diagram depicting a networked system 100 in which embodiments may be implemented. System 100 may include an access point 102, network devices 120 and 122, and backhaul network 130. Although two network devices (e.g., network device A 120 and network device B 122) are illustrated in FIG. 1, those of skill in the art having the benefit of the disclosure will appreciate that a network system may include more than two network devices. Network device A 120 and network device B 122 may be any type of device capable of wireless communications with access point 102. Examples of such devices include, but are not limited to laptop computers, tablet computers, desktop computers, music players, mobile phones, personal digital assistants etc.

Access point 102 may be a standalone access point or it may be incorporated into other devices. For example, access point 102 may be a MiFi® or similar type of access point. Alternatively, access point (AP) 102 may be a SoftAP (Software enabled Access Point) in which a mobile phone or other network device may be enabled, via software, to function as a mobile wireless hotspot.

Access point 102 includes two radios, radio A 104 and radio B 106. Radio A 104 and radio B 106 may be used as part of two different networking technologies. For example, in some embodiments, radio A 104 may be used to implement a WLAN interface, a BLUETOOTH® (Bluetooth) interface, a WiMAX interface, a ZigBee® interface, a Wireless USB interface, etc to communicate with peer network device A 120 and device B 122, while radio B 106 may be used to implement a backhaul networking technology. For example, radio B 106 may implement an LTE (Long-Term Evolution) networking technology to communicate with backhaul network 130. The embodiments are not limited to any particular networking technology for either radio A 104 or radio B 106. Further, although two radios are illustrated in FIG. 1, alternative embodiments may have more than two radios.

MAC (Media Access Control) unit 108 controls radio A 104. For example, MAC unit 108 may provide logic to implement, at least in part, the networking technology provided by radio A 104. Although not shown in FIG. 1, radio B 106 may also have a MAC layer. MAC unit 108 includes an acknowledgement (ACK) rate determination unit 110. ACK rate determination unit 110 includes logic to determine if transmissions from radio A 104 and radio B 106 are interfering with the successful reception of packets by network device A 120 or network device B 122. In some embodiments, ACK rate determination unit may use receiving a retransmission of a packet that was already successfully received as an indication that potential interference exists. In such embodiments, the retransmission by a network device indicates that an acknowledgement packet was not received. The reason for the non-receipt of the acknowledgement packet may be due to interference. In alternative embodiments, ACK rate determination unit 110 may determine metrics associated with receiving a packet from a network device (e.g., network device A 120 or network device B 122) to determine if the network device is within sufficient proximity to an access point such that interference may occur. If interference is determined to potentially exist, in some embodiments, ACK rate determination unit 110 may decrease an acknowledgment rate for communications with the affected network device.

In the example illustrated in FIG. 1, dashed lined 124 indicates a zone within which interference may occur. It should be noted that the zone of interference is not fixed and may vary from device to device, and may also vary depending on the communications environment (or technologies used) at a particular point in time. For purposes of the example, assume that network device 120 and network device 122 are in communications with access point 102. Further assume that network device 122 successfully received an acknowledgement packet while network device 120 did not. In this example, ACK rate determination unit 108 may decrease an acknowledgement rate with respect to network device 120, while leaving the acknowledgement rate initially established for network device 122 in place. Alternatively, access point 102 may determine based at least in part on a signal strength, that network device 120 is within sufficient proximity to access point 102 such that interference may occur and that network device 122 is far enough away from access point 102 (outside zone 124) such that interference is unlikely. In such cases, ACK rate determination unit 110 may decrease an acknowledgement rate for communications with network device 120, while leaving the initially established acknowledgement rate in place for network device 122.

It should be noted that proximity does not necessarily result in interference. For example, network device 120 may include filters of sufficient capability to filter out interference cause by nearly simultaneous transmission of packets from radio A 104 and radio B 106, while network device 122 may not have such filters. In this example, it is possible that interference may be detected for network device 122 and not detected for network device 120, even though network device 122 is farther from access point 102.

FIG. 1 shows radio A 104 and radio B as co-located. Radio A 104 and radio B 106 may be co-located within the same system-on-a-chip (SoC), within the same circuit board, within the same access point etc. However, it should be noted that the radios need not be co-located. For example, a radio on network device B 122 may interfere with operation of a radio network device A 120. Those of skill in the art having the benefit of the disclosure will appreciate that the systems and methods described below may be used in any wireless communications environment where one radio may interfere with communications of another radio.

Further details on example operation of system 100 and ACK rate determination unit 110 are provided below with respect to FIGS. 2-4.

FIG. 2 is a flowchart illustrating a method 200 for determining an acknowledgement bit rate according to embodiments. In some embodiments, some or all of the operations described in method 200 may be performed at a MAC (Media Access Control) layer of a network stack provided on access point 102. Method 200 begins at block 202 with reception of a packet at a first radio from a wireless network device. The packet is received at a bit rate that will be referred to as a packet reception bit rate, and may also be referred to as an uplink bit rate.

At block 204, an acknowledgment packet is transmitted to the wireless network device using the first radio. The packet is transmitted at an acknowledgement bit rate, also referred to as a downlink acknowledgement bit rate. In the absence of a determination that interference may be present, the bit rate for the acknowledgement packet may be determined from the packet reception bit rate. In general, the highest configured acknowledgement bit rate corresponding to the packet reception bit rate may be chosen. The highest configured acknowledgement bit rate will vary depending on the wireless networking technology in use. For example, in some embodiments, a packet reception bit rate may be fifty four Mbps (megabits per second), while the configured acknowledgement bit rates may be selected from twelve, six, and two Mbps. In such an example, the acknowledgement packet may be initially transmitted at an acknowledgement bit rate of twelve Mbps because it is the highest available acknowledgement bit rate and because it does not exceed the packet reception bit rate.

At block 206, a device executing the method determines that a retransmitted packet has been received. Upon receipt of a retransmitted packet, the method continues to block 208. If a retransmitted packet is not received, the method returns to block 202 to await the reception of subsequent packets.

A determination is made that the acknowledgement packet transmitted at block 204 was not received due to potential interference. In response to the determination, at block 208, the acknowledgement bit rate is decreased. In some embodiments, the acknowledgement bit rate may be decreased to the next lower bit rate. For example, assuming the example configured acknowledgment bit rates described above, the acknowledgement bit rate may be decreased from twelve Mbps to the next lower rate of six Mbps. In alternative embodiments, the acknowledgement bit rate may be decreased to the lowest configured acknowledgement bit rate. Using the example configured acknowledgement bit rates described above, the acknowledgement bit rate may be set to two Mbps. In some embodiments, once the lowest configured acknowledgement bit rate is reached, no further decreasing of the acknowledgement bit rate takes place. In some implementations, the acknowledgement bit rate is decreased by decreasing a modulation order. In alternative implementations, the acknowledgement bit rate is decreased by decreasing a coding rate. In further alternative embodiments, both a modulation order and a coding rate can be decreased.

After decreasing the acknowledgement rate in 208, the method returns to block 204 to retransmit the acknowledgement packet at the newly decreased bit rate. Blocks 204-208 may be repeated should further retransmissions of data packets be received.

FIG. 3 is a flowchart illustrating a method 300 for determining an acknowledgement bit rate according to alternative embodiments. Like method 200 above, in some embodiments, some or all of the operations described in method 200 may be performed at a MAC (Media Access Control) layer of a network stack provided on access point 102. Method 300 begins at block 302 with reception of a packet at a first radio from a wireless network device. The packet is received at a packet reception bit rate.

At block 304, one or more metrics are determined that are associated with the reception of the packet. In some embodiments, a RSSI (Received Signal Strength Indication) metric is calculated. In general, the RSSI metric is an indication of the power of a signal received at an antenna. A higher RSSI value indicates a stronger signal than a lower RSSI value. The RSSI metric can be used to determine whether the wireless network device transmitting the packet is sufficiently proximate to the device receiving the packet such that signal transmission may interfere with the receipt of an acknowledgement packet.

Other metrics can be used instead of or in addition to the RSSI metric. For example, the transmit power and transmit frequency of a second radio may be utilized to determine if interference with transmissions of the radio used to communicate with the network device is likely.

At block 306, a check is made to determine if the metrics indicate that interference may occur between a first radio transmission and a second radio transmission. In some embodiments, if the RSSI exceeds a configurable or predetermined threshold value, then the check at block 306 determines that interference is potentially present. The transmission power and frequency of the second radio may be compared to the transmission power and frequency of a first radio in order to determine if interference is likely.

If the check at block 306 determines that a second radio's transmission may interfere with a first radio's transmission, then at block 308, the acknowledgement bit rate may be decreased. As with method 200, in some embodiments, the acknowledgement bit rate may be decreased to a next lower bit rate. For example, assuming the example configured acknowledgment bit rates described above, the acknowledgement bit rate may be decreased from twelve Mbps to the next lower rate of six Mbps. In alternative embodiments, the acknowledgement bit rate may be decreased to the lowest configured acknowledgement bit rate. Using the example configured acknowledgement bit rates described above, the acknowledgement bit rate may be set to two Mbps. In some embodiments, once the lowest configured acknowledgement bit rate is reached, no further decreasing of the acknowledgement bit rate takes place. At block 310, the acknowledgement data packet is transmitted at the current acknowledgement data packet rate.

FIG. 4 is a sequence diagram 400 providing an example of the operation of method 200 above. In the example illustrated in FIG. 4, network device 120 communicates with an access point 102 configured to execute method 200. Access point 102 further communicates with backhaul network 130 to forward packets received from network device 420 on to the backhaul network. As described above in FIG. 1, the network communicably coupling network device 120 and access point 102 may be any type of wireless network. Backhaul network 130 may be an LTE network.

At operation 402, network device 120 transmits a packet to access point 102. The packet is transmitted and received at the first radio at the packet reception bit rate. At operation 404, access point 102 forwards the data packet to the backhaul network using the second radio.

At operation 406, access point 102 transmits an acknowledgement packet to acknowledge receipt of the packet using the first radio. In this example, access point 102 uses an acknowledgement packet bit rate to send the acknowledgement packet that is determined according to the packet reception bit rate. As indicated by the “X” in operation line 404, the acknowledgement packet is not properly received by network device 120. This may be due to interference due to the transmission by the second radio forwarding the data packet to the backhaul network occurring at operation 404. As indicated in the sequence diagram, operations 404 and 406 may take place approximately concurrently, simultaneously or nearly simultaneously such that there is overlap between the transmission by radio A and the transmission by radio B.

At operation 408, network device 120 retransmits the packet to access point 102. Access point 102 receives the retransmitted packet. In response to receiving the retransmitted packet, access point 102 determines that the reason for the retransmission is because network device 120 did not receive the acknowledgement packet as a result of interfering transmission occurring at operation 404 forwarding the packet to the backhaul network. Additionally, at operation 410, access point 102 decreases the acknowledgement bit rate. As described above, the acknowledgement bit rate may be decreased to the next lower configured acknowledgement bit rate. Alternatively, the acknowledgement bit rate may be decreased to a lowest configured acknowledgement bit rate. At operation 412, access point 102 resends the acknowledgement packet at the newly decreased acknowledgement bit rate.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 5 is a block diagram of one embodiment of an electronic device 500 including a mechanism for modifying an acknowledgement rate in the presence of interference. In some implementations, the electronic device 500 may be one of a laptop computer, a netbook, a mobile phone, a powerline communication device, a personal digital assistant (PDA), an access point or other electronic systems comprising a communications unit configured to exchange communications across communication networks. The electronic device 500 includes a processor unit 502 (possibly including multiple processors, multiple cores, multiple nodes, and/or implementing multi-threading, etc.). The electronic device 500 includes a memory unit 506. The memory unit 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 500 also includes a bus 510 (e.g., PCI, ISA, PCI-Express, HyperTransport®, InfiniBand®, NuBus, AHB, AXI, etc.), and one or more network interfaces 504 that may include wireless network interfaces (e.g., a WLAN interface, a Bluetooth® interface, a WiMAX interface, a ZigBee® interface, a Wireless USB interface, etc.) or wired network interfaces (e.g., an Ethernet interface, a powerline communication interface, etc.). In some implementations, the electronic device 500 may support multiple network interfaces—each of which is configured to couple the electronic device 500 to a different communication network.

The electronic device 500 also includes a communication unit 508. The communication unit 508 comprises a MAC unit 512 and acknowledgement rate determination unit 514 coupled to a first radio A 516. In some embodiments, the electronic device 500 includes a second communication unit 520 coupled to a second radio B 522. Although shown as independent units, either or both of communication unit 508 and communication unit 520 may be part of network interfaces 504. As described above in FIGS. 1-3, the MAC unit 512 and acknowledgement rate determination unit 514 implement functionality to dynamically determine an acknowledgement rate for communication with a peer network device. Any one of these functionalities may be partially (or entirely) implemented in hardware and/or on the processor unit 502. For example, the functionality may be implemented with an application specific integrated circuit, in logic implemented in the processor unit 502, in a dedicated processor included in the communication unit 508, in a co-processor on a peripheral device or card, etc. Further, realizations may include fewer or additional components not illustrated in FIG. 5 (e.g., video cards, audio cards, additional network interfaces, peripheral devices, etc.). The processor unit 502, the memory unit 506, and the network interfaces 504 are coupled to the bus 510. Although illustrated as being coupled to the bus 510, the memory unit 506 may be coupled to the processor unit 502.

While the embodiments are described with reference to various implementations and exploitations, it will be understood that these embodiments are illustrative and that the scope of the inventive subject matter is not limited to them. In general, techniques for modifying an acknowledgement rate as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for transmitting by an access point, comprising:
receiving, at an access point including a first radio using a first networking technology, a first packet from a network device via a wireless communication link communicably coupling the first radio and the network device using the first networking technology;
transmitting an acknowledgement packet from the first radio to the network device at a first bit rate in response to receiving the first packet;
receiving a second packet at the first radio, wherein the second packet is a retransmission of the first packet; and
retransmitting the acknowledgement packet from the first radio to the network device at a second bit rate in response to receiving the retransmission of the first packet, wherein the second bit rate is less than the first bit rate.

2. The method of claim 1, wherein the second packet received is a result of interference from a second radio of the access point, wherein the second radio uses a second networking technology.

3. The method of claim 1, further comprising:
determining a plurality of bit rate levels associated with the wireless communication link that are lower than the first bit rate; and
selecting one of the plurality of bit rate levels to be the second bit rate.

4. The method of claim 3, wherein said selecting one of the plurality of bit rate levels comprises:
determining from the plurality of bit rate levels a highest bit rate level; and
selecting the highest bit rate level to be the second bit rate.

5. The method of claim 1, further comprising, in response to receiving the retransmission of the first packet, reducing a bit rate associated with the first radio from the first bit rate to a lowest available bit rate associated with the wireless communication link.

6. The method of claim 1, wherein the first technology is Wi-Fi.

7. The method of claim 2, wherein the first radio comprises at least a WLAN radio and the second radio comprises a long-term evolution (LTE) radio, and wherein the network device comprises at least a WLAN radio, wherein the LTE radio introduces interference into the WLAN radio of the network device.

8. A method comprising:
receiving, at an access point including a first radio using a first networking technology, a first packet from a network device via a wireless communication link communicably coupling the first radio and the network device using the first networking technology;
detecting one or more metrics associated with the first packet that indicate a proximity of the network device with respect to the first radio;
determining to reduce a bit rate for transmission of packets based, at least in part, on the one or more metrics associated with the first packet; and
transmitting an acknowledgement packet from the first radio to the network device at the reduced bit rate in response to receiving the first packet.

9. The method of claim 8, wherein said detecting one or more metrics associated with the first packet that indicate a proximity of the network device with respect to the first radio, and said determining to reduce a bit rate for transmission of packets based, at least in part, on the one or more metrics associated with the first packet comprises:
determining a signal strength associated with the first packet that indicates the proximity of the network device with respect to the first radio; and
determining to reduce the bit rate for transmission of packets based, at least in part, on whether the signal strength associated with the first packet is greater than a predefined signal strength threshold.

10. The method of claim 9, wherein said determining a signal strength associated with the first packet comprises calculating a received signal strength indicator (RSSI) associated with the first packet.

11. A first network device comprising:
a first radio using a first networking technology, the first radio to:
receive a first packet from a second network device via a wireless communication link communicably coupling the first radio and the second network device using the first networking technology;
transmit an acknowledgement packet to the second network device at a first bit rate in response to reception of the first packet;
an acknowledgement rate determination unit to:
determine that interference between the first radio and a second radio potentially exists, and
in response to determining that interference between the first radio and the second radio potentially exists, modify an acknowledgement bit rate for transmission of packet acknowledgements.

12. The device of claim 11, wherein the acknowledgement rate determination unit is to, in response to determining that interference between the first radio and the second ratio potentially exists, modify the acknowledgment bit rate to a second bit rate, the second bit rate lower than the first bit rate; and
wherein a MAC (Media Access Control) unit transmits the acknowledgement packet from the first radio to the network device at the second bit rate.

13. The device of claim 11, wherein the acknowledgment rate determination unit is to determine that interference between the first radio and the second radio potentially exists in response to reception of a retransmission of the first packet.

14. The device of claim 11, wherein the acknowledgement rate determination unit is to determine that interference between the first radio and the second radio potentially exists in response to a determination that the network device is proximate to the second radio.

15. The device of claim 11, wherein the first networking technology comprises an LTE (Long-Term Evolution) networking technology.

16. The device of claim 11, wherein the device comprises an access point.

17. The device of claim 16, wherein the access point comprises a SoftAP (Software enabled Access Point).

18. The device of claim 11, wherein the network device and the first radio are Wi-Fi devices.

19. The device of claim 11, wherein the first radio comprises at least a WLAN radio and the second radio comprises a long-term evolution (LTE) radio, and wherein the network device comprises at least a WLAN radio, wherein the LTE radio introduces interference into the WLAN radio of the network device.

20. The device of claim 11, wherein the first radio is co-located with the second radio.

21. One or more machine-readable media having stored thereon machine executable instructions, which when executed by one or more processors causes the one or more processors to perform operations that comprise:
receiving, at an access point including a first radio using a first networking technology, a first packet from a network device via a wireless communication link communicably coupling the first radio and the network device using the first networking technology;
transmitting an acknowledgement packet from the first radio to the network device at a first bit rate in response to receiving the first packet;
receiving a second packet at the first radio, wherein the second packet is a retransmission of the first packet; and
retransmitting the acknowledgement packet from the first radio to the network device at a second bit rate in response to receiving the retransmission of the first packet, wherein the second bit rate is lower than the first bit rate.

22. The one or more machine-readable media of claim 21, wherein the second packet received is a result of interference from a second radio of the access point, wherein the second radio uses a second network technology.

23. The one or more machine-readable media of claim 21, wherein the operations further comprise:
determining a plurality of bit rate levels associated with the wireless communication link that are lower than the first bit rate;
selecting one of the plurality of bit rate levels to be the second bit rate.

24. The one or more machine-readable media of claim 23, wherein said selecting one of the plurality of bit rate levels comprises:
determining from the plurality of bit rate levels a highest bit rate level; and
selecting the highest bit rate level to be the second bit rate.

25. The one or more machine-readable media of claim 21, wherein the operations further comprise, in response to receiving the retransmission of the first packet, reducing a bit rate associated with the first radio from the first bit rate to a lowest available bit rate associated with the wireless communication link.

26. One or more machine-readable media having stored thereon machine executable instructions, which when executed by one or more processors causes the one or more processors to perform operations that comprise:
receiving, at an access point including a first radio using a first networking technology, a first packet from a network device via a wireless communication link communicably coupling the first radio and the network device using the first networking technology;
detecting one or more metrics associated with the first packet that indicate a proximity of the network device with respect to the first radio;
determining to reduce a bit rate for transmission of packets based, at least in part, on the one or more metrics associated with the first packet; and
transmitting an acknowledgement packet from the first radio to the network device at the reduced bit rate in response to receiving the first packet.

27. The one or more machine-readable media of claim 26, wherein said detecting one or more metrics associated with the first packet that indicate a proximity of the network device with respect to the first radio, and said determining to reduce a bit rate for transmission of packets based, at least in part, on the one or more metrics associated with the first packet comprises:
determining a signal strength associated with the first packet that indicates the proximity of the network device with respect to the first radio; and
determining to reduce the bit rate for transmission of packets based, at least in part, on whether the signal strength associated with the first packet is greater than a predefined signal strength threshold.

28. The one or more machine-readable media of claim 27, wherein said determining a signal strength associated with the first packet comprises calculating a received signal strength indicator (RSSI) associated with the first packet.

29. The one or more machine-readable media of claim 26, wherein said determining to reduce a bit rate for transmission of packets based, at least in part, on the one or more metrics associated with the first packet comprises reducing the bit rate associated with the first radio to a lowest available bit rate associated with the wireless communication link.

30. The one or more machine-readable media of claim 26, wherein the operations further comprise:
determining a plurality of bit rate levels associated with the wireless communication link that are lower than a current bit rate; and
selecting one of the plurality of bit rate levels to be the second bit rate.

31. A device comprising:
means for receiving, at an access point including a first radio using a first networking technology, a first packet from a network device via a wireless communication link communicably coupling the first radio and the network device using the first networking technology;
means for transmitting an acknowledgement packet from the first radio to the network device at a first bit rate in response to receiving the first packet;
means for receiving a second packet at the first radio, wherein the second packet is a retransmission of the first packet; and
means for retransmitting the acknowledgement packet from the first radio to the network device at a second bit rate in response to receiving the retransmission of the first packet, wherein the second bit rate is less than the first bit rate.

32. The device of claim 31, wherein the second packet received is a result of interference from a second radio, wherein the second radio uses a second networking technology.

33. The device of claim 31, further comprising:
means for determining a plurality of bit rate levels associated with the wireless communication link that are lower than the first bit rate; and
means for selecting one of the plurality of bit rate levels to be the second bit rate.

34. The device of claim 33, wherein said means for selecting one of the plurality of bit rate levels comprises:
means for determining from the plurality of bit rate levels a highest bit rate level; and
means for selecting the highest bit rate level to be the second bit rate.

35. The device of claim 31, further comprising means for reducing a bit rate associated with the first radio from the first bit rate to a lowest available bit rate associated with the wireless communication link in response to receiving the retransmission of the first packet.

36. The device of claim 31, wherein the first technology is Wi-Fi.

37. The device of claim 32, wherein the first radio comprises at least a WLAN radio and the second radio comprises a long-term evolution (LTE) radio, and wherein the network device comprises at least a WLAN radio, wherein the LTE radio introduces interference into the WLAN radio of the network device.
